(19) United States
(12) Patent Application Publication
(10) Pub. No.: US 2025/0219882 A1
(43) Pub. Date: Jul. 3, 2025

(54) METHOD AND APPARATUS FOR SIDELINK OPERATION ON UNLICENSED SPECTRUM

(71) Applicant: ZTE CORPORATION, Shenzhen, Guangdong (CN)

(72) Inventors: Youxiong LU, Shenzhen, Guangdong (CN); Yuzhou HU, Shenzhen, Guangdong (CN); Weimin XING, Shenzhen, Guangdong (CN); Haigang HE, Shenzhen, Guangdong (CN)

(21) Appl. No.: 18/848,545

(22) PCT Filed: Aug. 10, 2022
(86) PCT No.: PCT/CN2022/111554

§ 371 Date: Sep. 19, 2024

(51) Int. Cl. H04L 27/26; H04W 74/0808; H04W 92/18

(52) U.S. Cl. CPC H04L 27/2607; H04W 74/0808; H04W 92/18

(57) ABSTRACT

A wireless communication method for use in a wireless terminal is disclosed. The method comprises performing a channel access procedure on a channel based on a transmission starting point for a sidelink transmission, wherein the transmission starting point is a cyclic prefix extension period before/preceding the first SL OFDM symbol of a SL slot configured for the sidelink transmission, and wherein the cyclic prefix extension period is determined based on a number of channel access procedures performed for the sidelink transmission.

### CROSS REFERENCE

The present application is proposed based on International Application No. PCT/CN2022/111554, filed on Aug. 10, 2022, the disclosure of which is hereby incorporated by reference in its entirety.

### TECHNICAL FIELD

This document is directed generally to wireless communications, and in particular to sidelink communications.

### BACKGROUND

A sidelink is a generic wireless communication link between wireless communication devices (e.g., UE (user equipment)).

For the sidelink, the minimum resource allocation unit in time domain is a slot. Within a sidelink slot, a symbol is configured for the sidelink according to higher layer parameters sl-StartSymbol and sl-LengthSymbols, where sl-StartSymbol is the symbol index of the first symbol of sl-LengthSymbols consecutive symbols configured for the sidelink. Among these symbols configured for the sidelink, the UE shall not transmit physical sidelink share channel (PSSCH) in the last symbol configured for the sidelink, which is stated as 1st guard symbol 1 (GS-1) as shown in FIG. 1. In addition, the UE shall not transmit the PSSCH in the symbol immediately preceding the symbols which are used by a PSFCH (physical sidelink feedback channel) if the PSFCH is configured in this slot and is named as the 2nd guard symbol 2 (GS-2) as shown in FIG. 1.

For NR-U (NR (New Radio) operation on unlicensed spectrum), the UE may receive a DCI (downlink (DL) control information) indicating a UL (uplink) grant scheduling a PUSCH (physical UL shared channel) transmission by using Type 1/2 channel access procedures or indicating a DL assignment scheduling a PUCCH transmission by using the Type 1/2 channel access procedures. The DCI may also indicate a CPE (cyclic prefix extension) of the first OFDM symbol for the UL transmissions.

For the sidelink (SL) operation, there are two types of resource allocation/selection mechanism, i.e., mode 1/2 resource allocation/selection mechanism. In mode 1 resource allocation/selection mechanism, the resources are indicated/configured by a base station (e.g., eNB or gNB). In mode 2 resource allocation/selection mechanism, the resources are selected by UE via sensing mechanism (e.g., listen-before-talk (LBT)).

For the SL operation on the unlicensed spectrum, the UE/gNB may initial a COT (Channel Occupancy Time) for a SL transmission and may share the COT with other UEs. In order to maintain the COT, during the COT, a gap between two consecutive SL transmissions in time domain should be at most 25 or 16 microseconds and the CPE should be used for NR sidelink operation in a shared channel.

For example, in the guard symbols (e.g., GS-1 and GS-2), the transmission gap between the previous and next transmissions of a guard symbol should be smaller or equal to 25 or 16 microseconds. In this case, the CPE may be used to maintain the gap between two adjacent SL transmissions. However, how to determine a length of CPE for each transmission is not clear. Furthermore, how to determine the type of channel access procedure (e.g., Type 1, type 2 (Type 2A, Type 2B, or Type 2C) for SL transmissions with the CPE remains unclear.

This document relates to methods, systems, and devices for sidelink communications, and in particular to methods, systems, and devices for sidelink communications on an unlicensed spectrum.

### SUMMARY

The present disclosure relates to a wireless communication method for use in a wireless terminal. The method comprises performing a channel access procedure on a channel based on a transmission starting point for a sidelink transmission, wherein the transmission starting point is a cyclic prefix extension period before/preceding the first SL OFDM symbol of a SL slot configured for the sidelink transmission, and wherein the cyclic prefix extension period is determined based on a number of channel access procedures performed for the sidelink transmission.

Various embodiments may preferably implement the following features:

Preferably, a type of the channel access procedure is determined by the wireless terminal or configured by a sidelink grant scheduling the sidelink transmission or a sidelink configured grant for the sidelink transmission.

Preferably, the cyclic prefix extension period decreases as the number of channel access procedures performed for the sidelink transmission increases.

Preferably, the number of channel access procedures performed for the sidelink transmission increases by 1 and the cyclic prefix extension period decreases by a time delay T_{short-SL}.

Preferably, the T_{short-SL} is a positive value determined by the wireless terminal.

Preferably, the T_{short-SL} is determined based on a type of the channel access procedure.

Preferably, the channel access procedure is a Type 1 channel access procedure, wherein the number of channel access procedures performed for the sidelink transmission is greater than 1, and wherein performing the channel access procedure comprises:
performing a listen-before-talk procedure by using a counter value associated with sensing a channel status in another listen-before-talk procedure of a previous channel access procedure which is performed before the channel access procedure, or
performing a listen-before-talk procedure by using an ongoing Type 1 channel access procedure.

Preferably, the channel access procedure is a Type 2 channel access procedure, wherein performing the channel access procedure comprises:

initiating a listen-before-talk procedure by setting a counter value associated with sensing a channel status to a preconfigured value.

Preferably, the cyclic prefix extension period is determined by:

$${T}_{ext} = min ( max ( {T}_{ext}^{′} , 0 ) , {T}_{symb , ( l - 1 ) mod 7 \cdot {2}^{μ}}^{μ} ) , or$$

$${T}_{ext} = {T}_{ext}^{′} ,$$

wherein Tₑₓₜ is the cyclic prefix extension period, T_{symb,(i-1)mod 7·2}_{^{μ}}^{μ} is a length of the last symbol before the symbols configured for the sidelink transmission and Tₑₓₜ′ is determined by:

$${T}_{ext}^{′} = {\sum }_{k = 1}^{{C}_{i}} {T}_{symb , ( l - k ) mod 7 \cdot {2}^{μ}}^{μ} - {Δ}_{i} - {T}_{delay}$$

wherein Δᵢ is 25 microseconds or 16 microseconds with Cᵢ=1 for μ∈(0, 1),
Δᵢ is 16 microseconds with Cᵢ=1 for μ=2, or
Δᵢ is 25 microseconds or 16 microseconds with Cᵢ=2 for μ=2 or 3, and
wherein T_{delay} is determined based on the number of channel access procedures performed for the sidelink transmission.
wherein a symbol l is the first SL symbol for the sidelink transmission.

Preferably, wherein the cyclic prefix extension period is determined by:

$${T}_{ext} = {T}_{ext - max} - {T}_{delay}$$

wherein Tₑₓₜ is the cyclic prefix extension period, Tₑₓₜ₋ₘₐₓ is a maximum value of the cyclic prefix extension period and T_{delay} is determined based on the number of channel access procedures performed for the sidelink transmission.

Preferably, T_{delay} is a positive value implemented by the wireless terminal.

Preferably, T_{delay}=n×T_{short-SL},
wherein n is the number of channel access procedures performed for the sidelink transmission and T_{short-SL} is determined based on a type of the channel access procedure, and

Preferably, n=0 means that the channel access procedure performed for the sidelink transmission uses the maximum cyclic prefix extension period Tₑₓₜ₋ₘₐₓ.

Preferably, T_{short-SL} is 25 microseconds when the channel access procedure is a Type 2A channel access procedure.

Preferably, T_{short-SL} is 16 microseconds when the channel access procedure is a Type 2B channel access procedure.

Preferably, T_{short-SL} is 9 microseconds when the type of the channel access procedure is a Type 1 channel access procedure.

Preferably, the Tₑₓₜ₋ₘₐₓ is defined as:
a fixed value Tₘₐₓ, or
Tₑₓₜ₋ₘₐₓ=Tₘₐₓ+T_{symbol,l}^{u}/k wherein, k is a positive integer, T_{symbol,l}^{u} is a length of the first SL symbol in the slot configured for the sidelink transmission.

Preferably, the wireless communication method further comprises transmitting the sidelink transmission with the cyclic prefix extension period used by the channel access procedure when a result of the channel access procedure indicates that the channel is idle.

Preferably, a subcarrier spacing of the sidelink transmission is 15 kHz or 30 kHz, the channel access procedure is a Type 2A channel access procedure or a Type 2B channel access procedure, each type of guard symbol used in the sidelink transmission comprises 1 symbol.

Preferably, a subcarrier spacing of the sidelink transmission is 60 kHz, the channel access procedure is a Type 2B channel access procedure, each type of guard symbol used in the sidelink transmission comprises 1 symbol.

Preferably, a subcarrier spacing of the sidelink transmission is 60 kHz, the channel access procedure is a Type 2A channel access procedure or a Type 2B channel access procedure, each type of guard symbol used in the sidelink transmission comprises 2 symbols.

The present disclosure relates to a wireless terminal. The wireless terminal comprises:
a communication unit, and
a processor, configured to perform a channel access procedure on a channel based on a transmission starting point for a sidelink transmission,
wherein the transmission starting point is a cyclic prefix extension period before/preceding the first SL OFDM symbol of a SL slot configured for the sidelink transmission,
wherein the cyclic prefix extension period is determined based on a number of channel access procedures performed for the sidelink transmission.

Various embodiments may preferably implement the following feature:

Preferably, the processor is further configured to perform any of aforementioned wireless communication methods.

The present disclosure relates to a computer program product comprising a computer-readable program medium code stored thereupon, the code, when executed by a processor, causing the processor to implement a wireless communication method recited in any one of the foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF DRAWINGS

The above and other aspects and their implementations are described in greater detail in the drawings, the descriptions, and the claims.

FIG. 1 shows a schematic diagram of a slot configured for sidelink transmission.

FIG. 2 shows a schematic diagram of a network according to an embodiment of the present disclosure.

FIGS. 3 to 7 show schematic diagrams of SL transmissions according to embodiments of the present disclosure.

FIG. 8 shows an example of a schematic diagram of a wireless terminal according to an embodiment of the present disclosure.

FIG. 9 shows an example of a schematic diagram of a wireless network node according to an embodiment of the present disclosure.

FIG. 10 shows a flowchart of a method according to an embodiment of the present disclosure.

### DETAILED DESCRIPTION

FIG. 2 shows a schematic diagram of a network (architecture) according to an embodiment of the present disclosure. The network shown in FIG. 2 comprises a base station (BS), a relay (node) (e.g., a header UE) and two UEs UE1 and UE2. For example, the UE1 may be a mobile phone and the UE2 may be a smart gadget (e.g., smart glasses). As an alternative, the UE1 and/or UE2 may be an internet of things (IoT) device. The UE1 and/or UE2 may communicate with the BS directly or via relay. Based on a SL scheduling received from the BS, the relay, UE1 and UE2 may communicate with each other, where the communication between every two of the relays, UE1 and UE2 are called SL communications. The SL communication may be in the form of unicast, groupcast or broadcast. Furthermore, the UE2 may communicate with the BS/relay via the UE1. That is the UE1 may act as a UE/mobile relay.

In the present disclosure, more than one transmission starting point are applied, so as to increase channel access opportunities. Moreover, the CPE may be used to maintain the transmitting gap in the COT to be at most 25 or 16 microseconds.

This disclosure relates to methods, systems, and devices for sidelink transmission on the unlicensed spectrum by determining the SL transmission starting point or SL CPE, and performing the channel access procedure by using the ongoing channel access procedure or previous channel access procedure for the previous(first) transmission, in which, the previous(first) SL transmission with the first SL transmission starting point is determined by the (pre-)configured/indicated CPE indication and the resource of a SL grant, including dynamic grant, configured grant by eNB/gNB, or a UE determined grant.

In an embodiment, a length T_{ext_1} of the CPE for the first SL transmission is defined as:

$${T}_{ext \_ 1} = min ( max ( {T}_{ext}^{′} , 0 ) , {T}_{symb , ( l - 1 ) mod 7 \cdot {2}^{μ}}^{μ} )$$

where T_{symb,(i-1)mod 7·2}_{^{μ}}^{μ} is the length of the last symbol before the first symbol configured for the SL transmission. That is, the T_{ext_1} is at largest as T_{symb,(i-1)mod 7·2}_{^{μ}}^{μ}.

In this embodiment, the Tₑₓₜ′ is defined as:

$${T}_{ext}^{′} = {\sum }_{k = 1}^{{C}_{i}} {T}_{symb , ( l - k ) mod 7 \cdot {2}^{μ}}^{μ} - {Δ}_{i}$$

where Δᵢ is a gap for clear channel assessment (CCA) and may be defined as:
Δᵢ is 25 microseconds or 16 microseconds with Cᵢ=1 for μ∈(0, 1),
Δᵢ is 16 microseconds with Cᵢ=1 for μ=2, or
Δᵢ is 25 microseconds or 16 microseconds with Cᵢ=2 for μ=2 or 3.

Note that T_{ext_1} in this embodiment is applied to the first SL transmission, which is indicated by eNB/gNB in the mode 1 resource allocation/selection mechanism or is determined by the UE in the mode 2 resource allocation/selection mechanism.

In addition, when a SCS (sub-carrier spacing) is 15/30 kHz, Δᵢ=25 or 16 microseconds (μs) is supported. When the SCS is 60 kHz, Δᵢ=16 microseconds is supported. As an alternative, when the SCS is 60 kHz, Δᵢ=16 or 25 microseconds is supported if Cᵢ=2.

In this embodiment, a length T_{ext_2} of the CPE for the second and subsequent transmissions is defined as:

$${T}_{ext \_ 2} = {T}_{ext \_ 1} - {T}_{delay}$$

where T_{delay}=n×T_{short-SL}, n E {1, 2, . . . } and T_{short-SL} may be 25, 16, 9 microseconds, or other positive value.

For example, T_{short-SL} is 25 microseconds when the Type 2A channel access procedure is applied, T_{short-SL} is 16 microseconds when the Type 2B channel access procedure is applied, and T_{short-SL} is 9 microseconds when the Type 1 channel access procedure is applied. As an alternative, T_{short-SL} is determined by UE implementation.

In an embodiment, a length T_{ext_2} of the CPE for the SL transmissions (i.e., for the first SL transmission, the second SL transmission and so on) is defined as:

$${T}_{ext} = min ( max ( {T}_{ext}^{′} , 0 ) , {T}_{symb , ( l - 1 ) mod 7 \cdot {2}^{μ}}^{μ} )$$

where T_{symb,(i-1)mod 7·2}_{^{μ}}^{μ} is the length of the last symbol before the first symbol configured for the SL transmission. That is, the Tₑₓₜ is at largest as T_{symb,(i-1)mod 7·2}_{^{μ}}^{μ}.

In this embodiment, the Tₑₓₜ′ is defined as:

$${T}_{ext}^{′} = {\sum }_{k = 1}^{{C}_{i}} {T}_{symb , ( l - k ) mod 7 \cdot {2}^{μ}}^{μ} - {Δ}_{i} - {T}_{delay}$$

where Δᵢ is a gap for clear channel assessment (CCA) and may be defined as:
Δᵢ is 25 microseconds or 16 microseconds with Cᵢ=1 for μ∈(0, 1),
Δᵢ is 16 microseconds with Cᵢ=1 for μ=2, or
Δᵢ is 25 microseconds or 16 microseconds with Cᵢ=2 for μ=2 or 3.

In addition, T_{delay}=n×T_{short-SL}, n E {0, 1, 2, . . . } and T_{short-SL} may be 25 or 16 or 9 microseconds or another positive value.

For example, T_{short-SL} is 25 microseconds when the Type 2A channel access procedure is applied, T_{short-SL} is 16 microseconds when the Type 2B channel access procedure is applied, and T_{short-SL} is 9 microseconds when the Type 1 channel access procedure is applied. As an alternative, T_{short-SL} is determined by UE implementation.

Note that Tₑₓₜ in this embodiment is applied to each SL transmission, which is indicated by eNB/gNB in the mode 1 resource allocation/selection mechanism or is determined by the UE in the mode 2 resource allocation/selection mechanism.

In addition, when a SCS (sub-carrier spacing) is 15/30 kHz, Δᵢ=25 or 16 microseconds (μs) is supported. When the SCS is 60 kHz, Δᵢ=16 microseconds is supported. As an alternative, when the SCS is 60 kHz, Δᵢ=16 or 25 microseconds is supported if Cᵢ=2.

In the present disclosure, the first SL transmission refers to the first SL transmission performed by the UE when the UE schedules to perform a SL transmission at the resources indicated by the eNB/gNB (i.e., mode 1) or determined by the UE (i.e., mode 2). When the first SL transmission fails (e.g., the channel is not idle or is busy on the configured/determined resources), the UE performs the second transmission, and so on. Note that the UE may perform the first SL transmission and the second SL transmission simultaneously. For example, after performing the first SL transmission for a certain period, the UE performs the second SL transmission no matter whether the first SL transmission successes or not.

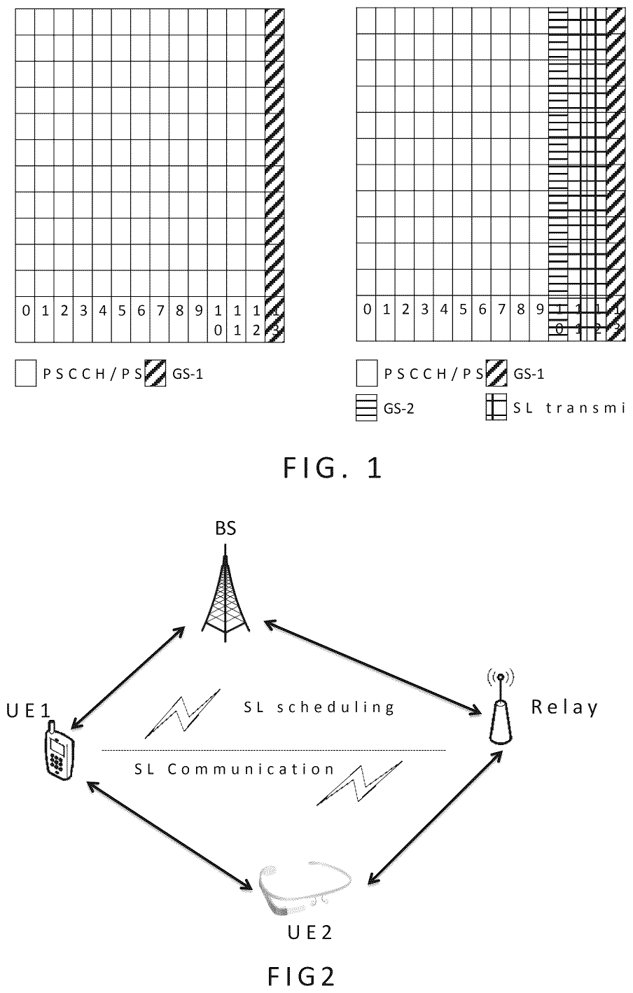

In some embodiments, for the SL transmission with a SCS (subcarrier spacing) of 15/30 kHz, the Type 2A/2B channel access (procedure) may be supported. In these embodiments, one symbol is configured/defined for each type of guard symbol (i.e., GS-1 or GS-2 shown in FIG. 1).

In some embodiments, for the SL transmissions with the SCS of 60 kHz, only the Type 2B channel access (procedure) is supported. In these embodiments, one symbol is configured/defined for each type of guard symbol (i.e., GS-1 or GS-2 shown in FIG. 1).

In some embodiment, for the SL transmissions with the SCS of 60 kHz, the Type 2A/2B channel access can be supported. In these embodiments, two symbols are configured/defined for each type of guard symbol (i.e., GS-1 or GS-2 shown in FIG. 1).

In some embodiments, the CPE parameters are configured by the BS (e.g., eNB or gNB) or pre-configured to the UE. In addition, the UE may get the resources for SL transmission via a sidelink dynamic grant, a configured grant, or a mode 2 resource selection.

In an embodiment, the UE receives the DCI indicating a SL grant scheduling a SL transmission using the Type 1/2 channel access procedure. As an alternative, the UE receives a SL configured grant indicating a SL configured grant for a SL transmission using the Type 1/2 channel access procedure. As another alternative, the UE selects a set of resources for the SL transmission and determines to perform the Type 1/2 channel access procedure. As a still another alternative, the UE determines to perform the Type 1/2 channel access procedure for the SL grant regardless of in either mode 1 or mode 2 resource allocation mechanism.

In an embodiment, the UE determines the first SL transmission which starts at the first transmission starting point, and the first transmission starting point is located at Tₑₓₜ₋ₘₐₓ seconds before/preceding the first SL OFDM symbol of a SL slot in SL grant, where Tₑₓₜ₋ₘₐₓ is a (pre-)configured value of the CPE. In other words, the first SL transmission is a SL transmission with a CPE-1 with a length Tₑₓₜ₋ₘₐₓ before the first SL symbol of the SL slot in the SL grant. For example, the Tₑₓₜ₋ₘₐₓ may be the aforementioned T_{ext_1}.

In an embodiment, the UE determines the second SL transmission which starts at the second transmission starting point and the second transmission starting point is located at T_{ext_2} seconds before/preceding the first SL OFDM symbol of the SL slot in the SL grant. That is the second transmission is the SL transmission with a CPE-2 with a length of T_{ext_2} before the first SL symbol of the SL grant, wherein which T_{ext_2} is less than Tₑₓₜ₋ₘₐₓ or equals to 0 (i.e. without a CPE).

As an alternative, the CPE-2 is within the duration of the CPE-1 or within the range of [−Tₑₓₜ₋ₘₐₓ, 0], where 0 indicates the start point of the first SL symbol of the SL slot in the SL grant. In other words, the second SL transmission is a transmission which is T_{delay} later than the first SL transmission.

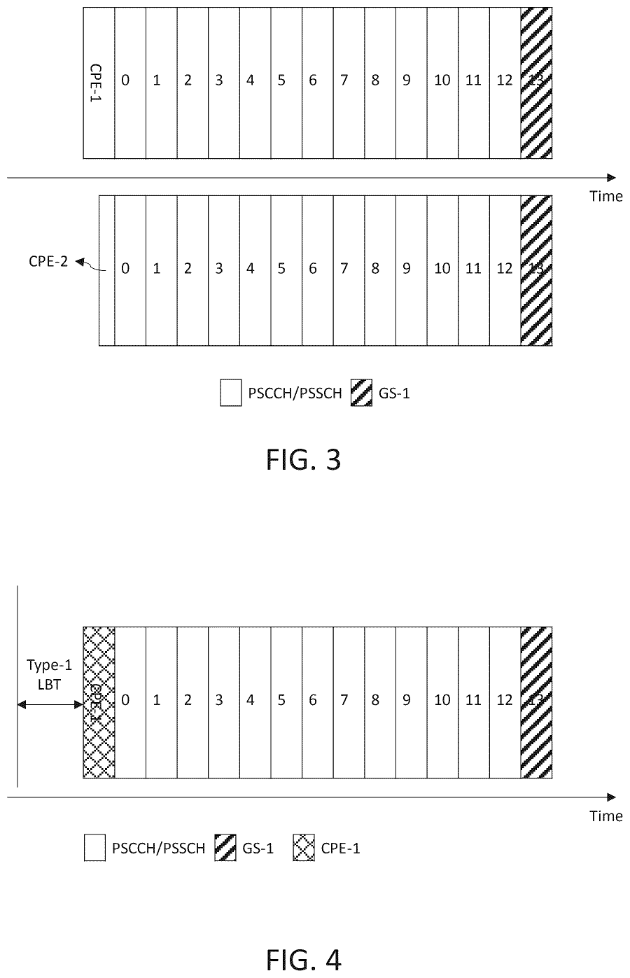

FIG. 3 shows a schematic diagram of SL transmissions according to an embodiment of the present disclosure. In FIG. 3, the UE schedules to perform a SL transmission in a slot. The first transmission starting point for the first SL transmission is at the CPE-1 before a symbol #0 of the slot (i.e., the first symbol of the slot configured for the SL transmission) and the second transmission starting point for the second SL transmission is at the CPE-2 before the symbol #0 of the slot. As can be seen from FIG. 3, the CPE-2 is shorter than CPE-1. Comparing to the first SL transmission, the SL symbols in the second SL transmission remain the same. The difference between the first SL transmission and the second SL transmission is at the length of CPE.

In an embodiment, the UE may transmit/perform the first SL transmission with the CPE-1 using the Type 1 channel access procedure after first sensing the channel to be idle during the slot durations of a defer duration T_{d} and after the counter N becomes 0 in the following step (4), wherein the counter N is adjusted by sensing the channel for additional slot duration(s) according to the steps described below:
1) set=Nᵢₙᵢₜ, where Nᵢₙᵢₜ is a random number uniformly distributed between 0 and CWₚ, and go to step (4);
2) if N>0 and the UE chooses to decrement the counter, set N=N−1;
3) sense the channel for an additional slot duration, and if the channel in the additional slot duration is idle, go to step (4); otherwise, go to step (5);
4) if N=0, stop; otherwise, go to step (2);
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step (4); else, go to step (5).

If at the beginning of the first (previous) SL transmission with the CPE-1, the counter N is not zero in step (4), (or if after the sensing before the first (previous) SL transmission, the channel is not idle), the UE may transmit the second SL transmission with the CPE-2 using the ongoing Type 1 channel access procedure after first sensing the channel to be idle during the slot durations of a defer duration T_{d}, and after the counter N is zero in the following step (4), wherein the counter Nis adjusted by sensing the channel for additional slot duration(s) according to the steps described below: (note that N is set to the N in the ongoing Type 1 channel access procedure)
2) if N>0 and the UE chooses to decrement the counter, set N=N−1;
3) sense the channel for an additional slot duration, and if the channel in the additional slot duration is idle, go to step (4); otherwise, go to step (5);
4) if N=0, stop; otherwise, go to step 2.
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step (4); else, go to step (5).

If the second SL transmission fails, the UE may perform above procedure till the CPE is zero or less than zero.

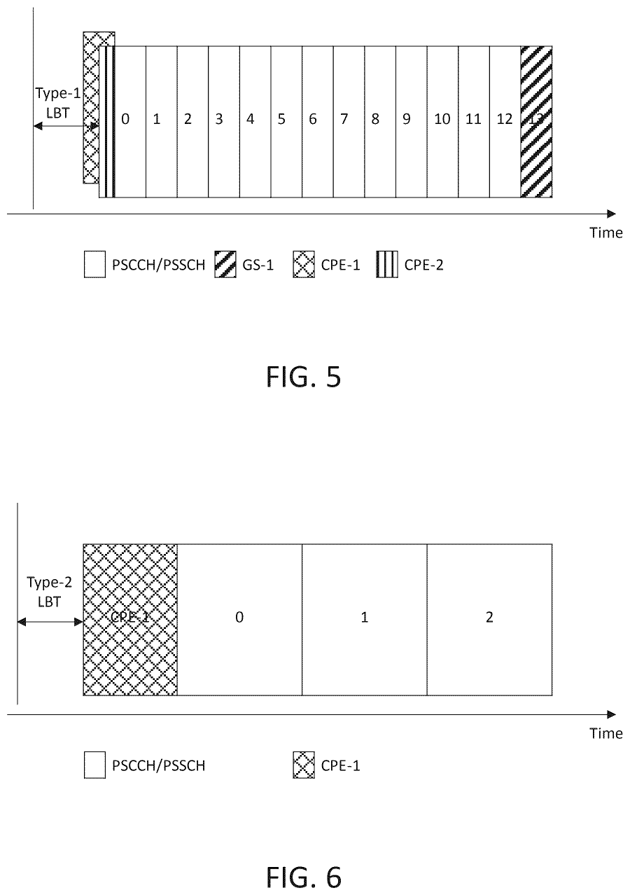

FIGS. 4 and 5 show schematic diagrams of the SL transmissions according to an embodiment of the present disclosure. In FIG. 4, the first SL transmission with the CPE-1 is performed. Specifically, the UE perform the first SL transmission by using the Type 1 channel access procedure (e.g., an LBT procedure or the aforementioned steps (1) to (6) for the first SL transmission). If the Type 1 channel access procedure successes, the UE determines that the channel is idle and transmits the first SL transmission with the CPE-1. If the first SL transmission fails (i.e., a result of the Type 1 channel access procedure (or LBT procedure) indicates that the channel is not idle), the UE performs the second SL transmission with the CPE-2 by using the ongoing Type 1 channel access procedure of the first SL transmission.

In an embodiment, the CPE parameters are configured by eNB/gNB or pre-configured to the UE. The UE may get the resources for the SL transmission via a sidelink dynamic grant, configured grant or the mode 2 resource selection by itself.

In this embodiment, the UE determines the first SL transmission that starts at the first transmission starting point which is located at Tₑₓₜ₋ₘₐₓ seconds preceding the first OFDM symbol of the slot configured for the SL transmission, where Tₑₓₜ₋ₘₐₓ is the (pre-)configured value of CPE. In other words, the first SL transmission is a SL transmission with a CPE-1 with the length of Tₑₓₜ₋ₘₐₓ before the first SL symbol of the SL slot in SL grant.

In an embodiment, the first SL transmission fails and the UE performs a second SL transmission. In this embodiment, the second SL transmission is the SL transmission with the CPE-2 before the first SL symbol of the SL grant, wherein the length of the CPE-2 is smaller than Tₑₓₜ₋ₘₐₓ or is 0 (i.e., the second SL transmission has no CPE).

As an alternative, the second transmission is the SL transmission with the CPE-2 before the first SL symbol of the SL grant. The CPE-2 is within the duration of the CPE-1 or within the range of [−Tₑₓₜ₋ₘₐₓ, 0], where 0 indicates the start point of the first symbol of the SL slot in the SL grant.

As another alternative, the second transmission is the SL transmission with the CPE-2 before the first SL symbol of the SL grant, wherein the length of the CPE-2 is 25 microseconds or 16 microseconds less than that of CPE-1.

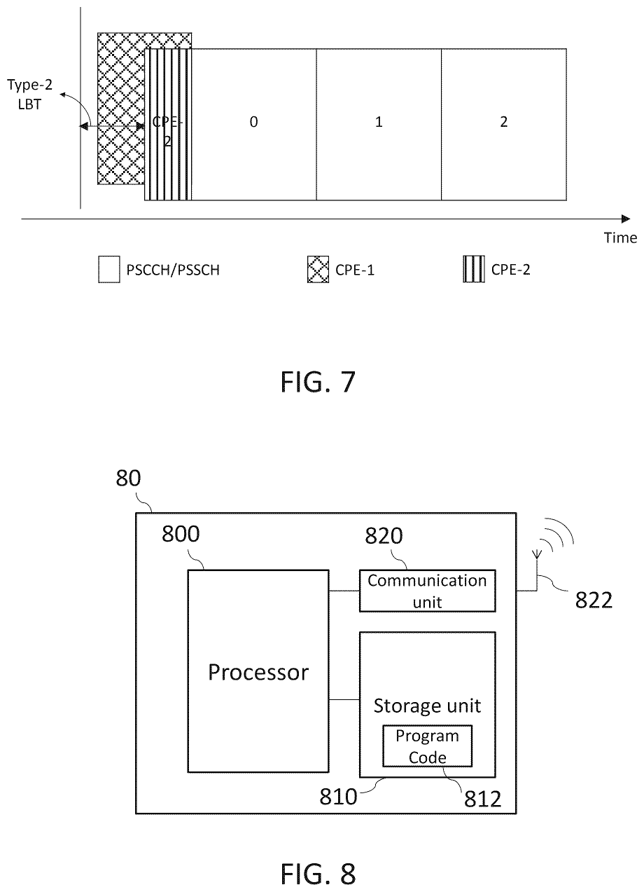

FIGS. 6 and 7 show schematic diagrams of SL transmissions according to an embodiment of the present disclosure. In FIG. 6, the UE performs a Type 2 channel access procedure (e.g., LBT procedure) for the first SL transmission with the CPE-1.

In an embodiment, the UE may transmit the first SL transmission with the CPE-1 immediately after sensing the channel to be idle for at least a sensing interval T_{short-SL}=25 microseconds or 16 microseconds by using the Type 2 (e.g., Type 2A/2B) channel access procedure.

In an embodiment, the result of the Type 2 (e.g., Type 2A/2B) channel access procedure before the first SL transmission with the CPE-1 indicates that the channel is busy (i.e., not idle), the UE may perform the second transmission with the CPE-2 immediately after sensing the channel to be idle by initiating another Type 2 channel access procedure for at least a sensing interval of T_{short-SL}=25 microseconds or 16 microseconds (see FIG. 7). Note that the type of Type 2 channel access procedure for the second SL transmission is the same as that for the first SL transmission. For the second SL transmission, the length of the CPE-2 is 25 microseconds or 16 microseconds or other positive values (i.e., the length of sensing duration for the performed channel access procedure) shorter than that of the CPE-1.

If the second SL transmission fails, the UE may perform the third SL transmission with a CPE-3 with a length which is shorter than that of the CPE-2, e.g., by 25 microseconds or 16 microseconds or other positive values, and so on till the corresponding CPE is less than 25 microseconds or 16 microseconds or other positive values or is zero.

FIG. 8 relates to a schematic diagram of a wireless terminal 80 according to an embodiment of the present disclosure. The wireless terminal 80 may be a user equipment (UE), a mobile phone, a laptop, a tablet computer, an electronic book or a portable computer system and is not limited herein. The wireless terminal 80 may include a processor 800 such as a microprocessor or Application Specific Integrated Circuit (ASIC), a storage unit 810 and a communication unit 820. The storage unit 810 may be any data storage device that stores a program code 812, which is accessed and executed by the processor 800. Embodiments of the storage unit 810 include but are not limited to a subscriber identity module (SIM), read-only memory (ROM), flash memory, random-access memory (RAM), hard-disk, and optical data storage device. The communication unit 820 may a transceiver and is used to transmit and receive signals (e.g., messages or packets) according to processing results of the processor 800. In an embodiment, the communication unit 820 transmits and receives the signals via at least one antenna 822 shown in FIG. 8.

In an embodiment, the storage unit 810 and the program code 812 may be omitted and the processor 800 may include a storage unit with stored program code.

The processor 800 may implement any one of the steps in exemplified embodiments on the wireless terminal 80, e.g., by executing the program code 812.

The communication unit 820 may be a transceiver. The communication unit 820 may as an alternative or in addition be combining a transmitting unit and a receiving unit configured to transmit and to receive, respectively, signals to and from a wireless network node (e.g., a base station).

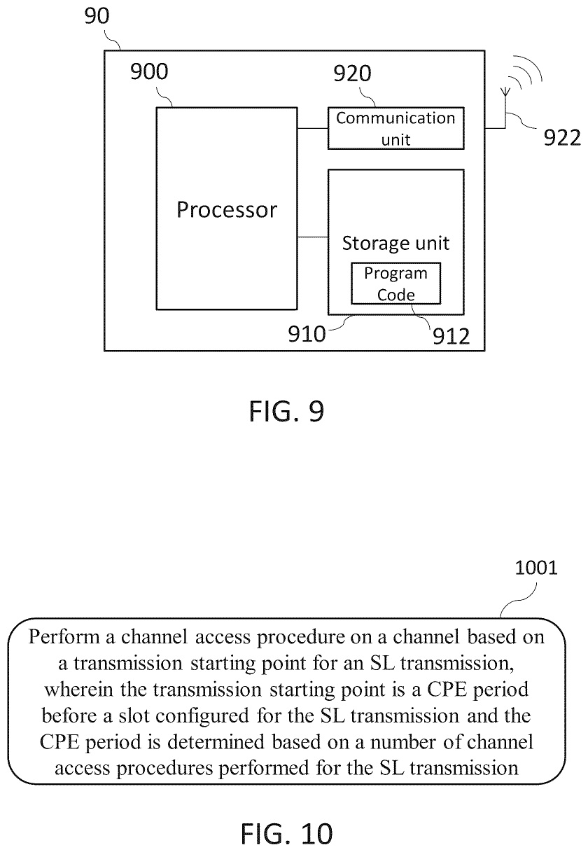

FIG. 9 relates to a schematic diagram of a wireless network node 90 according to an embodiment of the present disclosure. The wireless network node 90 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 90 may comprise (perform) at least one network function such as an access and mobility management function (AMF), a session management function (SMF), a user plane function (UPF), a policy control function (PCF), an application function (AF), etc. The wireless network node 90 may include a processor 900 such as a microprocessor or ASIC, a storage unit 910 and a communication unit 920. The storage unit 910 may be any data storage device that stores a program code 912, which is accessed and executed by the processor 900. Examples of the storage unit 910 include but are not limited to a SIM, ROM, flash memory, RAM, hard-disk, and optical data storage device. The communication unit 920 may be a transceiver and is used to transmit and receive signals (e.g., messages or packets) according to processing results of the processor 900. In an example, the communication unit 920 transmits and receives the signals via at least one antenna 922 shown in FIG. 9.

In an embodiment, the storage unit 910 and the program code 912 may be omitted. The processor 900 may include a storage unit with stored program code.

The processor 900 may implement any steps described in exemplified embodiments on the wireless network node 90, e.g., via executing the program code 912.

The communication unit 920 may be a transceiver. The communication unit 920 may as an alternative or in addition be combining a transmitting unit and a receiving unit configured to transmit and to receive, respectively, signals to and from a wireless terminal (e.g., a user equipment or another wireless network node).

FIG. 10 shows a flowchart of a method according to an embodiment of the present disclosure. The method shown in FIG. 10 may be used in a wireless terminal (e.g., UE) and comprises the following step:

Step 1001: Perform a channel access procedure on a channel based on a transmission starting point for an SL transmission, wherein the transmission starting point is a CPE period before/preceding the first SL OFDM symbol of a SL slot configured for the SL transmission and the CPE period is determined based on a number of channel access procedures performed for the SL transmission.

In this embodiment, the wireless terminal performs a channel access procedure (e.g. Type 1 channel access procedure, Type 2 channel access procedure or LBT procedure) on a channel (e.g. unlicensed spectrum or shared spectrum) based on a transmission starting point for an SL transmission. The transmission starting point is a CPE period before (the first symbol of) a slot configured for the SL transmission. The CPE period is determined based on the number of channel access procedure performed for the SL transmission. For example, the CPE period may decrease as the number of channel access procedures performed for the SL transmission increase. As a result, the wireless terminal may perform at least one channel access procedure for the SL transmission by using the CPE with different lengths. The chance of the wireless terminal successfully transmitting the SL transmission increases, therefore. In addition, the wireless terminal may not need to reschedule the SL transmission when the channel access procedure fails and only need to adjust the length of the CPE (period).

In an embodiment, a type of the channel access procedure is determined by the wireless terminal or configured by an SL grant scheduling the SL transmission or a SL configured grant for the SL transmission.

In an embodiment, the number of channel access procedures performed for the SL transmission increases by 1 and the CPE period decreases by a time delay T_{short-SL}. For example, the T_{short-SL} is a positive value determined by the wireless terminal. As an alternative or in addition, the T_{short-SL} is determined based on a type of the channel access procedure. For instance:
T_{short-SL} is 25 microseconds when the channel access procedure is the Type 2A channel access procedure,
T_{short-SL} is 16 microseconds when the channel access procedure is the Type 2B channel access procedure, or
T_{short-SL} is 9 microseconds when the channel access procedure is the Type 1 channel access procedure.

In an embodiment, the channel access procedure is the Type 1 channel access procedure. In this embodiment, the number of channel access procedures performed for the sidelink transmission is greater than 1. The wireless terminal performs the channel access procedure by performing a LBT procedure by using an ongoing Type 1 channel access procedure (e.g., ongoing LBT procedure). That is the LBT procedure for the channel access procedure is performed by using a counter value associated with sensing a channel status in another LBT procedure of a previous/former channel access procedure which is performed before the channel access procedure.

In an embodiment, the channel access procedure is the Type 2 channel access procedure. In this embodiment, the wireless terminal performs the channel access procedure by initiating a LBT procedure by setting a counter value associated with sensing a channel status to a preconfigured value. In other words, the wireless terminal initiating a fresh new LBT procedure.

In an embodiment, (a length of) the CPE period is determined by:

$${T}_{ext} = min ( max ( {T}_{ext}^{′} , 0 ) , {T}_{symb , ( l - 1 ) mod 7 \cdot {2}^{μ}}^{μ} ) , or$$

$${T}_{ext} = {T}_{ext}^{′} ,$$

wherein Tₑₓₜ is (the length of) the CPE period, T_{symb,(i-1)mod 7·2}_{^{μ}}^{μ} is a length of the last symbol before the symbols configured for the SL transmission and Tₑₓₜ′ is determined by:

$${T}_{ext}^{′} = {\sum }_{k = 1}^{{C}_{i}} {T}_{symb , ( l - k ) mod 7 \cdot {2}^{μ}}^{μ} - {Δ}_{i} - {T}_{delay}$$

wherein Δᵢ is 25 microseconds or 16 microseconds with Cᵢ=1 for μ∈(0, 1),
Δᵢ is 16 microseconds with Cᵢ=1 for μ=2, or
Δᵢ is 25 microseconds or 16 microseconds with Cᵢ=2 for μ=2 or 3, and
wherein T_{delay} is determined based on the number of channel access procedures performed for the SL transmission.
wherein a symbol l is the first SL symbol (configured) for the SL transmission.

In an embodiment, (a length of) the CPE period is determined by:

$${T}_{ext} = {T}_{ext - max} - {T}_{delay}$$

wherein Tₑₓₜ is (the length of) the CPE period, Tₑₓₜ₋ₘₐₓ is the maximum value of the cyclic prefix extension period and T_{delay} is determined based on the number of channel access procedures performed for the SL transmission.

In an embodiment, T_{delay} is a positive value implemented by the wireless terminal.

In an embodiment, T_{delay}=n×T_{short-SL},
wherein n is the number of channel access procedures performed for the sidelink transmission and T_{short-SL} is determined based on a type of the channel access procedure, and

In an embodiment, n=0 means that the channel access procedure performed for the sidelink transmission uses the maximum cyclic prefix extension period Tₑₓₜ₋ₘₐₓ.

For example, the T_{short-SL} is a positive value determined by the wireless terminal. As an alternative or in addition, the T_{short-SL} is determined based on a type of the channel access procedure. For instance:
T_{short-SL} is 25 microseconds when the channel access procedure is the Type 2A channel access procedure,
T_{short-SL} is 16 microseconds when the channel access procedure is the Type 2B channel access procedure, or
T_{short-SL} is 9 microseconds when the channel access procedure is the Type 1 channel access procedure.

In an embodiment, the Tₑₓₜ₋ₘₐₓ is defined as:
a fixed value Tₘₐₓ, or
Tₑₓₜ₋ₘₐₓ=Tₘₐₓ+T_{symbol,l}^{u}/k wherein, k is a positive integer, T_{symbol,l}^{u} is a length of the first SL symbol in the slot configured for the SL transmission.

In an embodiment, when a result of the channel access procedure indicates that the channel is idle, the wireless terminal transmits the SL transmission with the CPE period used by the channel access procedure.

In an embodiment of an SCS of the SL transmission being 15 kHz or 30 kHz, the channel access procedure is the Type 2A channel access procedure or the Type 2B channel access procedure and each type of guard symbol (i.e., GS-1 or GS-2 shown in FIG. 1) used in the SL transmission comprises 1 symbol.

In an embodiment of an SCS of the SL transmission being 60 kHz, the channel access procedure is the Type 2B channel access procedure and each type of guard symbol (i.e., GS-1 or GS-2 shown in FIG. 1) used in the SL transmission comprises 1 symbol.

In an embodiment of an SCS of the SL transmission being 60 kHz, the channel access procedure is the Type 2A channel access procedure or the Type 2B channel access procedure and each type of guard symbol (i.e., GS-1 or GS-2 shown in FIG. 1) used in the SL transmission comprises 2 symbols.

Note that the CPE period in the present disclosure may refer to the period configured for (transmitting) the CPE.

The following illustrates an embodiment for the method shown in FIG. 10. In this embodiment, the UE schedules to perform an SL transmission, wherein the resources (e.g., slot) for the SL transmission is either configured by a BS/eNB/gNB or determined by the UE itself. The UE performs a first channel access procedure for the SL transmission. The first channel access procedure (e.g., LBT procedure) is performed based on a first transmission starting point which is a first CPE period before (the first symbol of) the slot (configured) for the SL transmission. Because this is the first time of the UE performing the first channel access procedure for the SL transmission, the first CPE period may be set as a preconfigured (maximum) value. Note that the SL transmission with the first CPE may be called “first SL transmission” in the present disclosure.

If a result of the first channel access procedure indicates that the channel is idle, the UE transmits the first SL transmission (i.e., the SL transmission with the first CPE (period)).

If the result of the first channel access procedure indicates that the channel is not idle, the UE performs a second channel access procedure for the SL transmission. The second channel access is performed based on a second transmission starting point which is a second CPE period before (the first symbol of) the slot (configured) for the SL transmission. Because the UE has performed the first channel access procedure for the SL transmission, the second CPE period is set to be smaller than the first CPE. How to determine the second CPE period may be referred to aforementioned embodiments.

If a result of the second channel access procedure indicates that the channel is idle, the UE transmits the SL transmission by using the second CPE (i.e., the SL transmission with the second CPE (period) or the second SL transmission in the present disclosure).

If the result of the second channel access procedure indicates that the channel is busy, the UE performs a third channel access procedure for the SL transmission, and so on (e.g., until the CPE period used for the channel access procedure becomes smaller than a threshold value (e.g., 0)).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
performing a channel access procedure on a channel based on a transmission starting point for a sidelink transmission,
wherein the transmission starting point is a cyclic prefix extension period before/preceding a first SL OFDM symbol of a SL slot configured for the sidelink transmission, and
wherein the cyclic prefix extension period is determined based on a number of channel access procedures performed for the sidelink transmission.

2. The wireless communication method of claim 1, wherein a type of the channel access procedure is determined by the wireless terminal or configured by a sidelink grant scheduling the sidelink transmission or a sidelink configured grant for the sidelink transmission.

3. The wireless communication method of claim 1, wherein the cyclic prefix extension period decreases as the number of channel access procedures performed for the sidelink transmission increases.

4. The wireless communication method of claim 1, wherein the number of channel access procedures performed for the sidelink transmission increases by 1 and the cyclic prefix extension period decreases by a time delay T_{short-SL}.

5. The wireless communication method of claim 4, wherein the T_{short-SL} is a positive value determined by the wireless terminal.

6. The wireless communication method of claim 4, wherein the T_{short-SL} is determined based on a type of the channel access procedure.

7. The wireless communication method of claim 1, wherein the channel access procedure is a Type 1 channel access procedure,
wherein the number of channel access procedures performed for the sidelink transmission is greater than 1, and
wherein performing the channel access procedure comprises:
performing a listen-before-talk procedure by using a counter value associated with sensing a channel status in another listen-before-talk procedure of a previous channel access procedure which is performed before the channel access procedure, or
performing a listen-before-talk procedure by using an ongoing Type 1 channel access procedure.

8. The wireless communication method of claim 1, wherein the channel access procedure is a Type 2 channel access procedure, wherein performing the channel access procedure comprises:
initiating a listen-before-talk procedure by setting a counter value associated with sensing a channel status to a preconfigured value.

9. The wireless communication method of claim 1, wherein the cyclic prefix extension period is determined by:
$${T}_{ext} = min ( max ( {T}_{ext}^{′} , 0 ) , {T}_{symb , ( l - 1 ) mod 7 \cdot {2}^{μ}}^{μ} ) , or$$
$${T}_{ext} = {T}_{ext}^{′} ,$$
wherein Tₑₓₜ is the cyclic prefix extension period, T_{symb,(i-1)mod 7·2}_{^{μ}}^{μ} is a length of the last symbol before the symbols configured for the sidelink transmission and Tₑₓₜ′ is determined by:
$${T}_{ext}^{′} = {\sum }_{k = 1}^{{C}_{i}} {T}_{symb , ( l - k ) mod 7 \cdot {2}^{μ}}^{μ} - {Δ}_{i} - {T}_{delay}$$
wherein Δᵢ is 25 microseconds or 16 microseconds with Cᵢ=1 for μ∈(0, 1),
Δᵢ is 16 microseconds with Cᵢ=1 for μ=2, or
Δᵢ is 25 microseconds or 16 microseconds with Cᵢ=2 for μ=2 or 3, and
wherein T_{delay} is determined based on the number of channel access procedures performed for the sidelink transmission, or T_{delay} is a positive value implemented by the wireless terminal;
wherein a symbol l is the first SL symbol for the sidelink transmission.

10. The wireless communication method of claim 1, wherein the cyclic prefix extension period is determined by:
$${T}_{ext} = {T}_{ext - max} - {T}_{delay}$$
wherein Tₑₓₜ is the cyclic prefix extension period, Tₑₓₜ₋ₘₐₓ is a maximum value of the cyclic prefix extension period and T_{delay} is determined based on the number of channel access procedures performed for the sidelink transmission or T_{delay} is a positive value implemented by the wireless terminal.

11. (canceled)

12. The wireless communication method of claim 10, wherein the T_{delay}=n×T_{short-SL},
wherein n is the number of channel access procedures performed for the sidelink transmission and T_{short-SL} is determined based on a type of the channel access procedure, and
wherein n=0 means that the channel access procedure performed for the sidelink transmission uses the maximum cyclic prefix extension period Tₑₓₜ₋ₘₐₓ.

13. The wireless communication method of claim 4, wherein:
T_{short-SL} is 25 microseconds when the channel access procedure is a Type 2A channel access procedure,
T_{short-SL} is 16 microseconds when the channel access procedure is a Type 2B channel access procedure, or
T_{short-SL} is 9 microseconds when the type of the channel access procedure is a Type 1 channel access procedure.

14. The wireless communication method of claim 10, wherein the Tₑₓₜ₋ₘₐₓ is defined as:
a fixed value Tₘₐₓ, or
T_{ext_max}=Tₘₐₓ+T_{symbol,l}^{u}/k, wherein, k is a positive integer, T_{symbol,l}^{u} is a length of the first SL symbol in the slot configured for the sidelink transmission.

15. The wireless communication method of claim 1, further comprising:
transmitting the sidelink transmission with the cyclic prefix extension period used by the channel access procedure when a result of the channel access procedure indicates that the channel is idle.

16. The wireless communication method of claim 1, wherein a subcarrier spacing of the sidelink transmission is 15 kHz or 30 kHz,
wherein the channel access procedure is a Type 2A channel access procedure or a Type 2B channel access procedure, and
wherein each type of guard symbol used in the sidelink transmission comprises 1 symbol.

17. The wireless communication method of claim 1, wherein a subcarrier spacing of the sidelink transmission is 60 kHz,
wherein the channel access procedure is a Type 2B channel access procedure, and
wherein each type of guard symbol used in the sidelink transmission comprises 1 symbol.

18. The wireless communication method of claim 1, wherein a subcarrier spacing of the sidelink transmission is 60 kHz,
wherein the channel access procedure is a Type 2A channel access procedure or a Type 2B channel access procedure, and
wherein each type of guard symbol used in the sidelink transmission comprises 2 symbols.

19. A wireless terminal, comprising:
a communication unit, and
a processor, configured to perform a channel access procedure on a channel based on a transmission starting point for a sidelink transmission,
wherein the transmission starting point is a cyclic prefix extension period before/preceding a first SL OFDM symbol of a SL slot configured for the sidelink transmission,
wherein the cyclic prefix extension period is determined based on a number of channel access procedures performed for the sidelink transmission.

20. The wireless terminal of claim 19, wherein the processor is further configured to perform the wireless communication method of claim 2.

21. A computer program product comprising a computer-readable program medium code stored thereupon, the code, when executed by a processor, causing the processor to implement a wireless communication method recited in claim 1.
